(19) United States
(12) Patent Application Publication
(10) Pub. No.: US 2019/0208388 A1
(43) Pub. Date: Jul. 4, 2019

(54) Control Device and Method for Coordinating Motor Vehicle Function Components With Each Other and/or With at Least One Vehicle-External Function Component

(71) Applicant: AUDI AG, Ingolstadt (DE)

(72) Inventors: Frank OLDEWURTEL, Hagen (DE); Thomas ROTTACH, München (DE)

(73) Assignee: AUDI AG, Ingolstadt (DE)

(21) Appl. No.: 16/088,108

(22) PCT Filed: Feb. 10, 2017
(86) PCT No.: PCT/EP2017/053006

§ 371 Date: Sep. 25, 2018

(30) Foreign Application Priority Data
Apr. 2, 2016 (DE) 10 2016 004 032.7

(51) Int. Cl. H04W 4/48; H04M 1/725; H04L 12/28; H04W 4/20; B60W 50/00; B60W 10/30; B60N 2/02; B60Q 3/80; B60H 1/00

(52) U.S. Cl. CPC H04W 4/48; H04M 1/72569; H04L 12/2825; H04W 4/20; B60W 50/00; B60W 2710/30; B60N 2/0248; B60Q 3/80; B60H 1/00971; H04L 2012/285; H04M 2250/12; B60W 10/30

(57) ABSTRACT

The invention relates to a control device and to a method for coordinating at least one function component in a motor vehicle having a vehicle-external function component. The at least one function component is combined in the motor vehicle by means of a gateway apparatus into a vehicle domain. The at least one vehicle-external function component is combined by means of a respective gateway apparatus into at least one vehicle-external domain. Context messages are generated for each domain and the domains output their context messages to the control device via their respective gateway apparatuses. A memory apparatus of the control device provides at least one context rule. A monitoring apparatus of the control device controls a function component indicated in the context rule based on the at least one context rule and according to the context messages.

### TECHNICAL FIELD

The invention relates to a method and to a controller for coordinating operation of at least one functional component in a motor vehicle with at least one functional component not on board the vehicle. An example functional component in a motor vehicle may be the infotainment system thereof. An example functional component not on board a vehicle may be a domestic appliance in a building. The invention also relates to a motor vehicle comprising the controller according to the invention.

### BACKGROUND

Nowadays, the number of personalized services available to users on cellphones is increasing. In these services, users can input explicit information to adapt them to their needs, thereby personalizing the service with their own preferences. To address users' increasing needs in terms of comfort, lifestyle and safety in vehicles too, it is important to allow users to configure and customize their personal experience space. In this respect, the personal experience space goes beyond cellphones and considers in particular the user and their current situation regardless of domain. Example domains are the motor vehicle and its surroundings, the home, a network cloud and the internet, and mobile terminals (mobile devices/wearables), e.g. a smartphone or a smartwatch.

DE 10 2010 047 411 A1 discloses a method by means of which recommendations for at least one driver assistance function tailored to a current vehicle use are established automatically. In doing so, the recommendation takes account of both user behavior and a vehicle usage profile. By means of this known method, only the use of in-vehicle functional components is tailored to the current situation within the vehicle. Functional components not on board the vehicle are not considered.

DE 10 2013 223 684 A1 describes a method for giving recommendations for a plurality of vehicle occupants. These recommendations consider preference information on all vehicle occupants. These preferences can also be learned by a server, which receives corresponding observation data from an observation unit within the vehicle by means of a communications unit. As a result of this method, therefore, functional components on board the vehicle can be tailored to the vehicle occupants currently within the vehicle. In doing so, the preferences of all vehicle occupants are taken into account. An event external to the vehicle, for example in a residential building, cannot be taken into account during operation of the vehicle components.

US 2013 0030 645 A1 describes a method for operating functional components in a motor vehicle, which method also adapts the functional components depending on the vehicle occupants currently within the vehicle. To do so, a profile analysis of the vehicle occupants located in the motor vehicle is carried out. Using this method, it is not possible to adapt the onboard functional components according to operating states of functional components not on board the vehicle, such as domestic appliances in a home.

### BRIEF DESCRIPTION OF THE DRAWINGS/FIGURES

FIG. 1 illustrates a schematic view of a plurality of domains each including functional components, and of a controller for controlling the functional components, according to some embodiments of this disclosure.

FIG. 2 is a diagram illustrating a logical structure formed by the controller and the gateway devices of the domains, according to some embodiments of this disclosure.

FIG. 3 is a diagram illustrating the generation of context messages on the basis of aggregation instructions, according to some embodiments of this disclosure.

FIG. 4 is a diagram illustrating a different degree of abstraction of the context messages, according to some embodiments of this disclosure.

FIG. 5 illustrates a schematic view of the controller and the gateway devices to illustrate communication therebetween, according to some embodiments of this disclosure.

FIG. 6 is a flow diagram illustrating an embodiment of the method according to the invention.

FIG. 7 is a schematic view illustrating the creation of a context rule, according to some embodiments of this disclosure.

FIG. 8 is a schematic view of the motor vehicle and a “private home” domain that are operated by means of a context rule, according to some embodiments of this disclosure.

FIG. 9 illustrates a schematic view of the motor vehicle from FIG. 1, in which a vehicle component is controlled on the basis of a context rule, according to some embodiments of this disclosure.

### DETAILED DESCRIPTION

Networking different domains, e.g. the “motor vehicle” domain with the “home” or “office” domain and the “mobile terminal” domain is complex since status data on the functional components located in each domain, e.g. the infotainment system in the motor vehicle and the domestic appliances in a home, makes it necessary for the corresponding status data to be exchanged between the domains at high data rates. If a vehicle is connected to the internet via a mobile communications connection, all the data traffic for recording the relevant operating states or sensor data of functional components would have to be routed to the motor vehicle over said mobile communications connection. For example, to control the infotainment system on the basis of domestic appliances in a home, all the sensor data and status data on the domestic appliances would have to be transmitted to the motor vehicle over the mobile communications connection so that the infotainment system can be controlled within the vehicle on the basis of said data. This may overstretch the available data rate. In addition, it may be advantageous to carry out pre-processing in the transmitting domain such that at least some of the data is processed at the point where it is produced.

The problem addressed by the invention is to coordinate functional components in a motor vehicle with one another and/or with at least one functional component not on board the vehicle.

The problem is solved the by subject matter of the independent claims. Advantageous developments of the invention are disclosed by the features of the dependent claims, the following description, and the drawings.

The invention provides a method for coordinating operation of at least one functional component in a motor vehicle with operation of another functional component of the motor vehicle and/or with operation of at least one functional component not on board the vehicle. In general, a functional component in this respect may in particular be: an apparatus, a sensor, an actuator, an application, a software service. The functional components are combined to form groups, which are referred to here as domains, a functional component being assigned to a domain according to the location where it is found. For example, the at least one functional component in the motor vehicle is arranged in an in-vehicle domain. Each domain comprises a gateway device. Communication between the domains takes place by means of the gateway devices. The at least one offboard functional component is accordingly combined to form at least one offboard domain, each domain comprising a gateway device.

Context messages describing a situation currently occurring in each domain or the situation at hand therein are generated for or regarding each domain. In the context of the invention, context messages are communications notices between system components. In other words, they are not notices output to users. In this respect, each context message is generated from respective sensor data and/or status data of the at least one functional component and/or from at least one other context message in accordance with a predefined aggregation instruction or aggregation rule. In this simplest case, a context message can thus represent the sensor data of a functional component. By combining sensor data of a plurality of functional components, a relatively complex or comprehensive context message can be generated. In addition, a context message can be generated by processing sensor data. For example, a predefined voice command can be detected by voice recognition and the successful detection can be signaled as a context message. A predefined gesture can also be detected by means of gesture recognition and/or facial recognition and the successful detection can be signaled as a context message. A context message can also be based on at least one other context message in order to thus abstract or break down the situation description.

The domains send their context messages to a controller by means of their respective gateway devices. Therefore, the controller contains information, in the form of context messages, on the situations occurring in the domains or the situations at hand therein. As a result, there is no need to collect all the sensor data as raw data in the controller. Instead, the context messages make it possible to provide an abstracted description of the situation in the domain. This advantageously reduces the required data rate. In addition, as a result pre-processing is carried out in the sending domains in the aforementioned manner; this can reduce the complexity of the processing in the controller.

In the controller, a memory device provides at least one context rule. Each context rule is generated in an automated manner or by a user by means of an operator device. A user can thus freely define a context rule of this kind. Context rules can also be generated in an automated manner by observing user behavior. Each context rule provides at least one predefined control instruction for at least one predefined functional component of each of the domains. By means of the control instruction, therefore, at least one functional component is controlled. Consequently, one or more functional components can be controlled by means of a context rule, specifically in each case by means of one or more control instructions.

However, the at least one control instruction is only sent to the respective at least one functional component if at least one predefined context message is determined by the controller, i.e. received from a domain or formed by the controller itself. The context rule thus assigns at least one context message to each control instruction. The context rule can in particular also include a plurality of context messages as a condition for sending the control instruction. On the basis of the at least one context rule, a monitoring device of the control device lastly controls the at least one functional component stated in each context rule. In other words, the monitoring device reacts to the received context messages as specified or prescribed by the at least one context rule.

The invention is advantageous in that the controller collects information on the situations occurring in the plurality of different domains or the situations at hand therein, and functional components are controlled by control instructions regardless of domain if, on the basis of the context messages, a predefined situation has arisen in one or more of the domains. For example, a user, e.g., in their motor vehicle, can have a light switched on, i.e. a vehicle light acting as a functional component is controlled by a control instruction if, as a result of a context message from e.g., the “private home” domain, the context message stating for example that someone is in the house is received. A corresponding context message may then read “Person in house”, for example. In this case, it is not necessary to continuously send sensor data from all the movement detectors in the house, for example. Instead, on the basis of an appropriate aggregation rule in the “private home” domain, the sensor data is compiled to the extent that only the status or situation “Person in house” is sent to the controller as a context message. In addition, users can freely set the context rules by means of the operator device; in other words, during operation of the controller, users can alter the links produced between the functional components by the context rule. By way of example, the operator device can be implemented by means of an infotainment system of the motor vehicle and/or as an application on a mobile terminal and/or as an application program on a personal computer (PC).

The invention also covers optional developments, the features of which result in additional advantages.

According to a development, the at least one functional component of the in-vehicle domain comprises at least one of the following: an infotainment system, a seat adjustment control unit, in particular comprising a motor for adjusting a seat position and/or a heating element, an air-conditioning and/or ventilation device, a lighting device, a positioning device, a navigation device. Said positioning device can, for example, be based on a receiver for a positional signal of a GNSS (Global Navigation Satellite System), for example GPS (Global Positioning System). A positioning device of this kind then forms a source of sensor data and is thus not controlled by a control instruction as part of a context rule.

In relation to the at least one offboard domain, one development provides that at least one of the following is included as such a domain. An appliance network of a building comprising at least one domestic appliance as a functional component can form a domain. An example domestic appliance can be a washing machine, an oven, a building sensor system or a building light. A portable mobile terminal comprising at least one application program as a functional component can form another domain. In this way, the terminal can be connected to the functional components of the motor vehicle by means of context rules. An internet area comprising at least one internet service as a functional component can form a domain. For example, web portals of social networks can each form a functional component. Events on the social networks are then reported or signaled to the controller by means of context rules.

In a development, each gateway device of each of the domains transforms or converts the context messages from each domain into a predefined message format before they are sent. Preferably, the message format is the same for all gateway devices. The conversion produces the advantage whereby context messages from one domain are all provided in the same message format in the controller regardless of the manufacturer format for the context messages. Doing so means that, when changing or installing a functional component in one of the domains, the controller does not need adapting in order to be able to interpret the context messages of the new functional components.

In a development, the aggregation instructions for forming the context messages are executed by the respective gateway devices and/or at least one functional component and/or by the controller. By executing the instructions in a functional component, for example, the sensor data of the component itself is already combined into a context message, which requires a lower data rate than the sensor data in order to be transmitted to the gateway device. Advantageously, the gateway device can bundle sensor data and/or context messages and combine these into a new context message by means of an aggregation instruction, and in doing so is advantageously in communication with all the functional components involved. Advantageously, context messages from a plurality of domains can be combined in the controller by means of an aggregation instruction.

In a development, the controller is provided by a server apparatus, e.g., a server, not on board the vehicle, and in this respect the gateway device of the in-vehicle domain also sends its context messages from this domain to the controller. The server apparatus can, for example, be an internet server, and can be formed for example on the basis of a processor device such as a computer or a computer network. This development results in the advantage whereby, regardless of a current radio connection between the motor vehicle and the vehicle surroundings, the server apparatus can receive context messages from the other domains and can check them by means of its monitoring device.

In a development, the controller is conversely provided on board the vehicle. This produces the advantage whereby functional components can be combined at least with one another in the motor vehicle if there is no radio connection to the vehicle surroundings.

In a development, each context rule comprises a condition part and an action part, the condition part describing the at least one context message and the action part describing the at least one control instruction and the condition part and the action part being linked to form an IF-THEN rule (IF condition, THEN action). As a result, users can use the operator device to input into the condition part all the context messages that are to be taken into account, and then input the desired control instruction into the action part.

The context rules can be configured and/or added and/or deleted during operation of the motor vehicle. Therefore, user-defined context messages, automated context messages and/or those provided for example by a manufacturer of the motor vehicle by way of remote maintenance can be added, or existing context rules can be modified or removed. The manufacturer can for example analyze context rules anonymously (e.g. statistical frequency of use) and then suggest them to other users as new context rules if a predefined use criterion is satisfied.

The invention also relates to the aforementioned controller for controlling at least one functional component on the basis of at least one context rule. The controller comprises a receiver device designed to receive, from a gateway device of at least one offboard domain, context messages describing a current situation occurring in the respective domain and context messages from a motor vehicle. If the controller is arranged in the motor vehicle, the receiver device can receive the context messages from the offboard domains via a mobile communications connection or a WLAN (Wireless Local Area Network) connection, for example. The context messages from the motor vehicle itself can for example be received directly via a vehicle bus or a vehicle data network, e.g. an Ethernet. If the controller is provided outside the motor vehicle, the receiver device can be designed to receive all context messages via a communications connection based on a communication protocol, e.g. the internet protocol (IP).

The controller further comprises a memory device that is designed to provide at least one context rule that is either generated in an automated manner or defined by a user by means of an operator device. In the aforementioned manner, each context rule provides at least one predefined control instruction for at least one predefined functional component in the event that at least one predefined context message is received by the controller or is determined on the basis of at least one received context message by means of a separate aggregation instruction. To implement these context rules, a monitoring device is provided and is designed to control the at least one functional component stated in the at least one context rule on the basis of the respective context rule.

Where the controller is provided in a motor vehicle, another aspect of the invention is produced that covers a motor vehicle comprising the controller according to the invention and at least one functional component coupled to the controller for receiving control instructions.

Embodiments of the invention are described below. In the drawings:

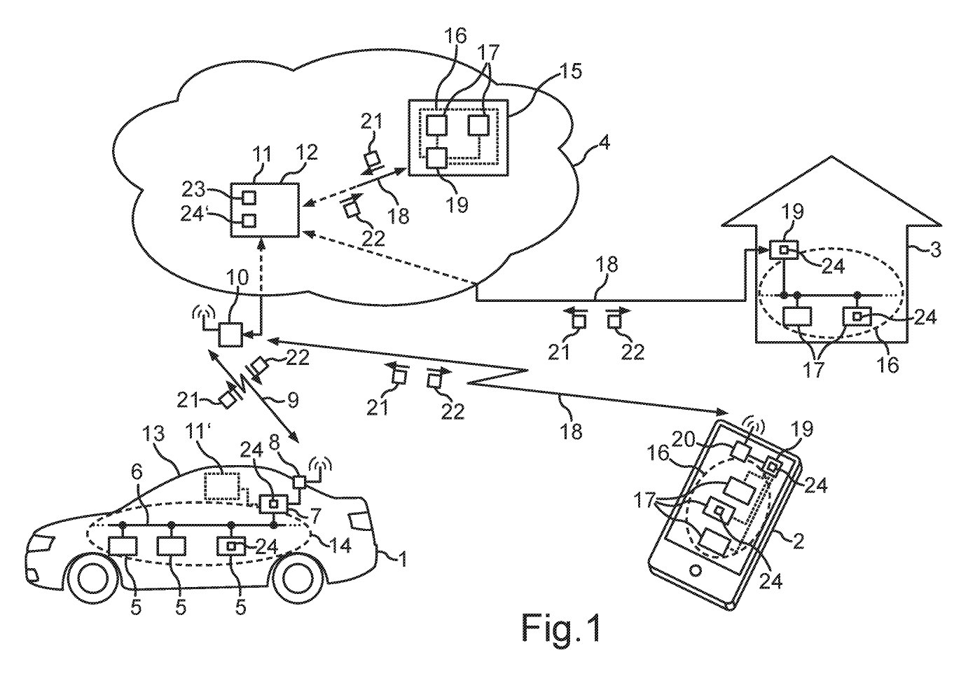

FIG. 1 is a schematic view of a plurality of domains each comprising functional components, and of a controller for controlling the functional components;

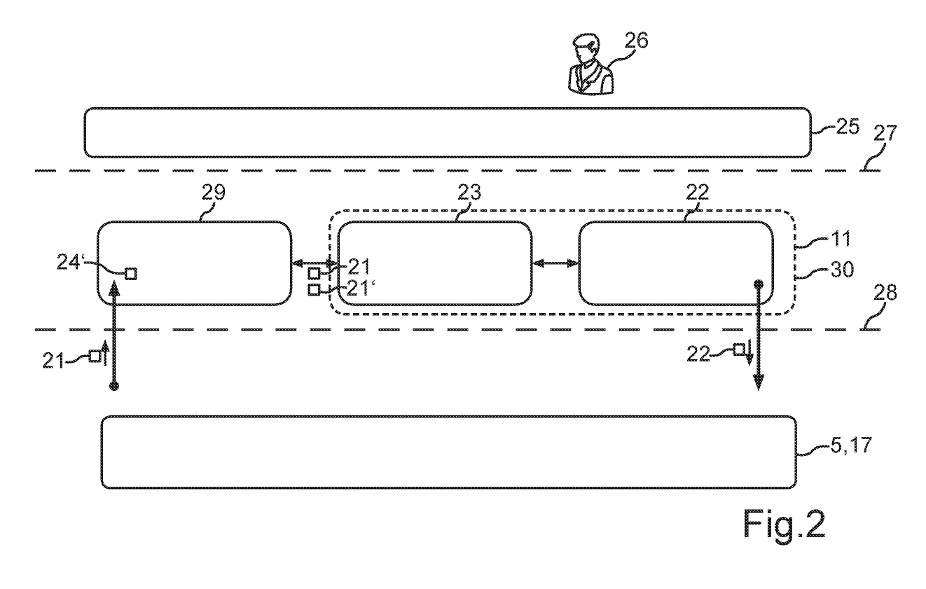

FIG. 2 is a diagram illustrating a logical structure formed by the controller and the gateway devices of the domains;

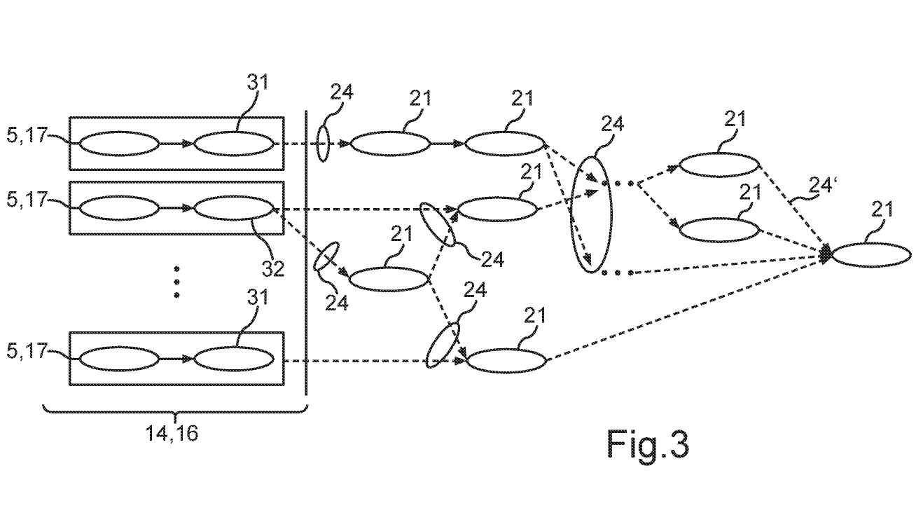

FIG. 3 is a diagram illustrating the generation of context messages on the basis of aggregation instructions;

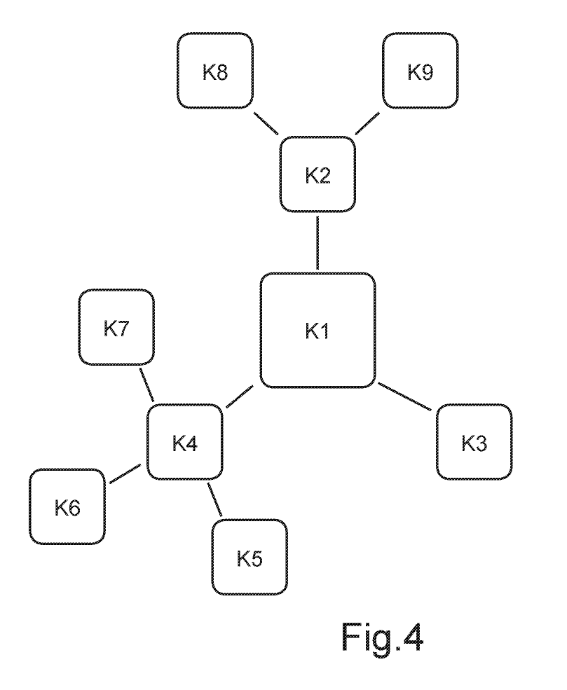

FIG. 4 is a diagram illustrating a different degree of abstraction of the context messages;

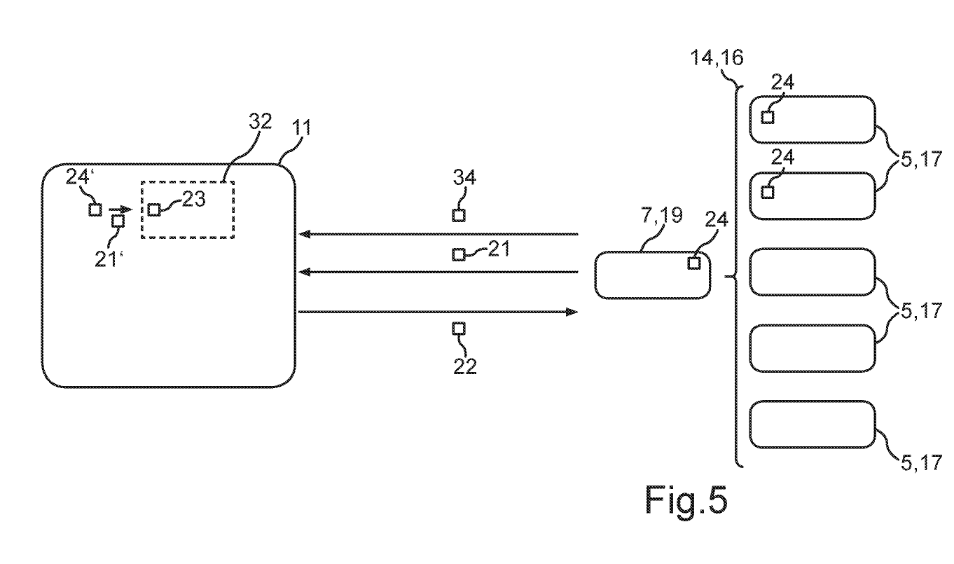

FIG. 5 is a schematic view of the controller and the gateway devices to illustrate communication therebetween;

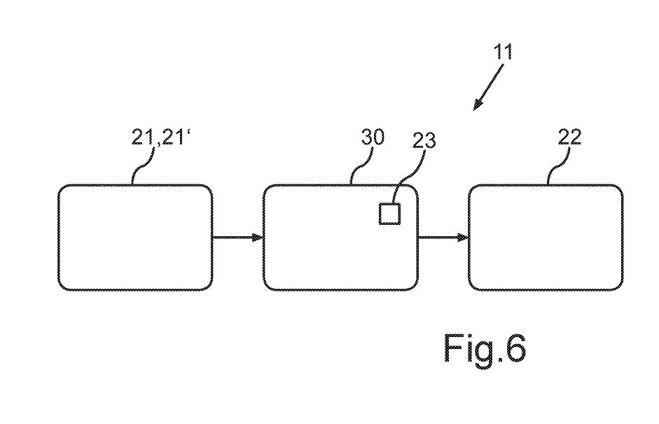

FIG. 6 is a flow diagram illustrating an embodiment of the method according to the invention;

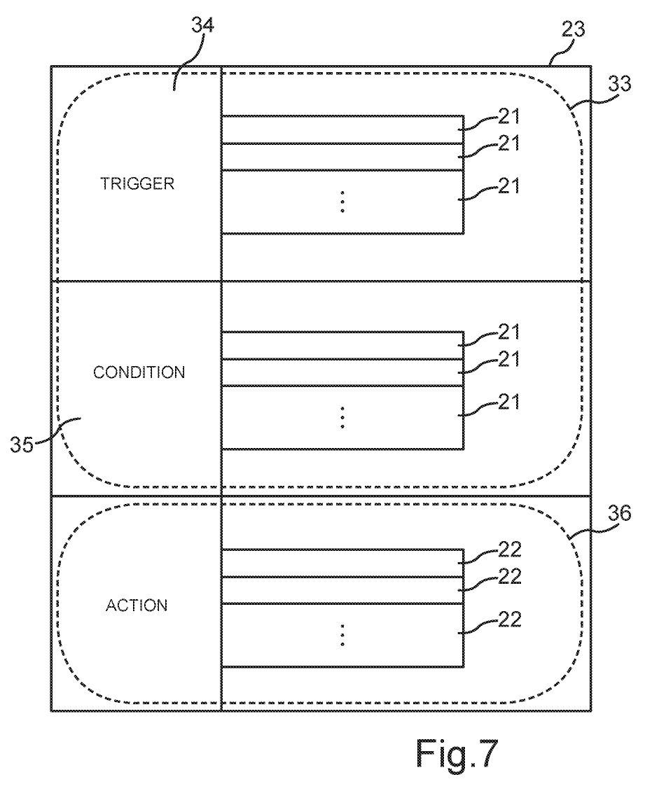

FIG. 7 is a schematic view illustrating the creation of a context rule;

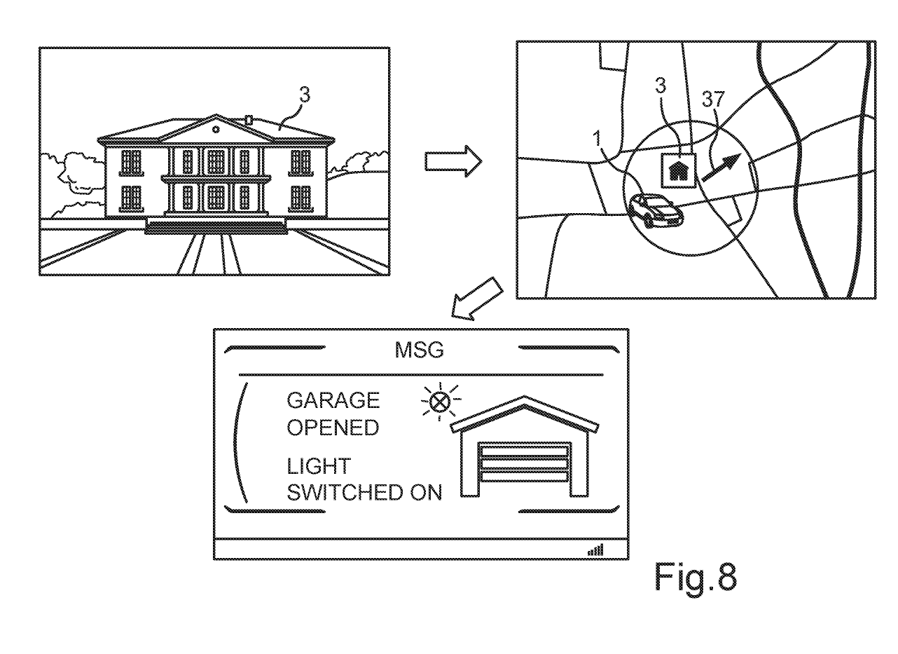

FIG. 8 is a schematic view of the motor vehicle and a “private home” domain that are operated by means of a context rule; and

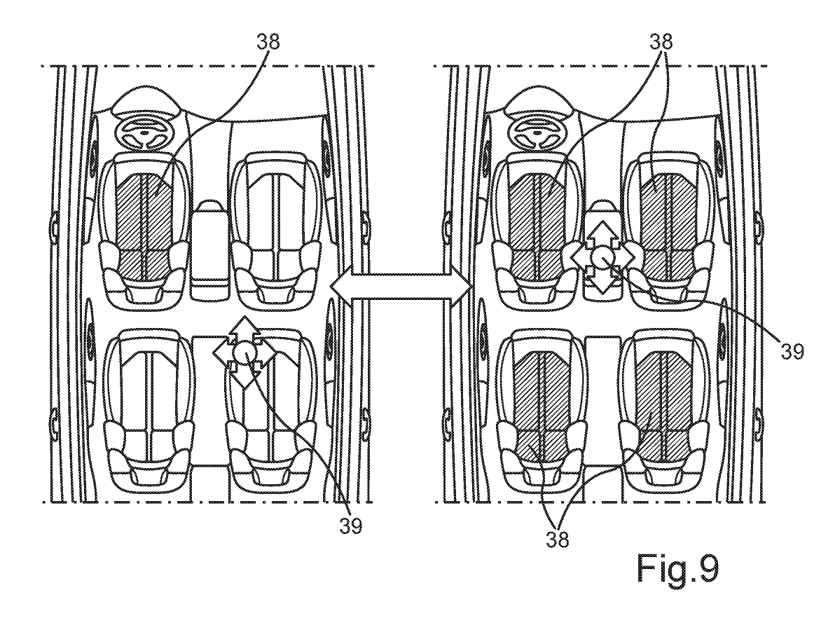

FIG. 9 is a schematic view of the motor vehicle from FIG. 1, in which a vehicle component is controlled on the basis of a context rule.

The embodiments explained below are preferred embodiments of the invention. In the embodiments, the described components of the embodiments constitute individual features of the invention that are to be considered in isolation from one another and each independently develop the invention, and so should also be taken as a constituent of the invention, even individually or in a different combination from that disclosed. In addition, additional features to those already described can also be added to the described embodiments.

Elements having the same function have been provided with the same reference numerals in the drawings.

FIG. 1 shows a motor vehicle 1 of a user, a mobile portable terminal 2, e.g., a smartphone, a residential building 3, which may be the private home of the user, and the internet 4. The motor vehicle 1 can comprises a plurality of functional components 5, which include for example an infotainment system and/or an air-conditioning device and/or a vehicle light, to mention just a few possible functional components. The functional components 5 can be coupled to a gateway device 7, which may be for example a control device of the motor vehicle, via a communications device 6, e.g., a communications network such as Ethernet, or bus systems such as a CAN bus (Controller Area Network). In addition, the motor vehicle 1 can comprise a communications device 8, which may be for example a mobile communications module or a WLAN module. Via a radio connection 9, the communications device 8 can exchange data with a radio-based communications network, e.g., a mobile communications network 10 or a WLAN. As a result, a communications connection is provided to a controller 11, which in the example shown in FIG. 1 can be formed by a server apparatus 12 of the internet 4. Alternatively, an in-vehicle controller 11′ can also be provided, for example by a processor device 13 of the motor vehicle 1.

With respect to the controllers 11, 11′, the gateway device 7 of each functional component 5 can represent a domain 14 of the motor vehicle 1. In other words, domain-related data is exchanged between the controller 11, 11′ and the vehicle components 5 by means of the gateway device 7. If the controller 11′ is arranged in the motor vehicle 1, in this case communication directly between the vehicle components 5 and the controller 11 can be provided.

In the terminal 2, the residential building 3 and in an internet area 15 of the internet 4, it is also possible to form respective offboard domains 16 that can each comprise functional components 17 and are provided with respective communications connections 18 to the controller 11, 11′ by means of respective gateway devices 19 of each domain 16. In the terminal 2, the functional components 17 can each be formed, for example, by an application program of the terminal 2. In the residential building 3, the functional components 17 can be formed, for example, by domestic appliances and/or building sensors. In the internet area 15, the functional components 17 can be formed, for example, by internet services, e.g. internet portals.

The gateway device 19 of the mobile terminal 2 can, for example, be formed by a program module that provides the communications connection 18 via the radio module 20 of the terminal 2. The gateway device 19 of the residential building 3 can, for example, be a microcontroller or personal computer that provides the communications connection 18 to the controller 11 by means of a fixed network cable and can optionally use the radio connection 9 to provide a communications connection to the in-vehicle controller 11′. The gateway device 19 of the internet area 15 can, for example, be formed on the basis of a server computer.

In the following, it has been assumed that the controller 11 is provided as a server apparatus 12 on the internet 4. By means of the communications connections 9, 18, context messages 21 are sent to the controller 11 by means of the respective gateway devices 7, 19 of the domains 14, 16. Each context message 21 displays or signals a particular status or status change in the domains 14, 16, i.e., describes the current situation in the respective domains. In response to context messages 21, the controller 11 sends control instructions 22 to individual functional components 5, 17. Each context rule 23 determines which control instruction 22 is sent by the controller 11 according to which context message 21. The context messages 21 can directly comprise or contain sensor data from sensors of each functional component 5, 17. In addition, the context messages 21 can also be ready-combined or ready-aggregated content or messages that may be formed by the functional components 17 themselves or by the gateway devices 19 via respective aggregation rules 24. In addition, further aggregation rules 24′ may be provided for additional combining of context messages 21 in the controller 11.

FIG. 2 illustrates how a user 26 can use an operator device 25 to operate the controller 11 via a user interface 27. The operator device 25 can be implemented or provided, for example, by means of an infotainment system of the motor vehicle 1 and/or an application program of the terminal 2. The user 26 can input context rules 23 using said device. At the functional components 5, 17, a communications interface 28 is implemented and can be used to merge sensor data and/or status data as context messages 21 for a context aggregation 29 on the basis of aggregation instructions 24, 24′. By means of a monitoring device 30 of the controller 11, the context rules 23 can then be implemented on the basis of context messages 21 from the domains 14, 16 and on the basis of additional context messages 21′, as generated in the controller 11 by means of the aggregation instructions 24′. If a condition specified in the context rule 23 is met for the context messages 21, 21′, notification and automation can be implemented by the monitoring device 30 on the basis of each control instruction 22 of the context rule 23.

FIG. 3 illustrates how each functional component 5, 17 is rendered actuable in relation to the communications interface 28. By means of the communications interface 28 for functional components, as shown in FIG. 3, communication to interfaced functional components across the domains 14, 16 is provided by means of notices such as “Status” (description of the status of the functional components), “Info” (registration of the functional components in the controller 11 and/or of a gateway 19) and “Command” (for executing control instructions 22). The data structure associated with a functional component will be discussed below. A functional component carries information on itself and on the status (current state) it is currently experiencing. A functional component 5, 17 is, for example, a light switch, a volume control, a remaining range calculation, or a distance to destination calculation. The data structure for this can be, for example: the name of the functional component; the subject; the data type; a piece of information “Sensor”/“Actuator”/“Other”; metadata, and optionally other attributes.

FIG. 3 illustrates how status data and/or sensor data 31 from the individual functional components 5, 17 can be prepared by means of the aggregation rules 24, 24′ and thus how the context messages 21 may depend on a plurality of heterogeneous data sources. This can be carried out by reading out functional components 5, 17, e.g. sensors and/or actuators and/or an application. In the figure, preparation of the different data results in discrete data types that can be processed by means of a programming language.

FIG. 4 illustrates how contexts K1 to K9 are generated by processing and combining the status data and/or sensor data 31 of the context messages 21 with one another. Step by step, the raw data (status data and/or sensor data 31) are accumulated or abstracted more and more, thus producing a semantically higher-quality representation that can be signaled by a respective context message 21.

The hierarchical structure according to FIG. 4 for generating higher-quality (more complex) contexts shows how the higher-quality context K1 is generated by being augmented by lower-quality contexts K2, K3, K4. In formal terms, therefore, this can be described by means of an aggregation instruction 24, 24′. In this case, a context K1-K9 corresponds to a particular situation that is relevant and thus should be reacted to. Contexts K1-K9 can, for example, be “Journey to location X”, “Arrival at destination or close to y”, “Parking process initiated”, or “Remaining range too low”. The use of semantically higher-quality contexts (formed from other context messages) becomes easier and easier for the controller as the degree of abstraction increases. Relevant contexts can be predefined in context rules 23, or alternatively learned automatically from machine learning methods and algorithms, which can then in turn generate context rules 23 in an automated manner.

FIG. 5 illustrates the resulting relationship between the controller 11 and the individual functional components 5, 17. In a memory device 32 of the controller 11, the context rules 23 set by means of the operator device 25 are provided. On the basis of the aggregation instructions 24, 24′, the context messages 21, 21′ are generated from the status data and/or sensor data 31, the context messages 21 being transmitted to the controller 11 via the gateways 7, 19. For the controller 11 to know which functional components 5, 17 are available, the functional components 5, 17 available in each domain 14, 16 can first be registered in the controller 11 in announcement notices 34.

FIG. 6 shows the evaluation of the context rules 23 by the controller 11. A context rule 23 provides that for each context described by one or more context messages 21, 21′, a follow-up action is generated as a control instruction 22. This control instruction 22 is executed according to the evaluation/interpretation of a context rule 23 configured/created previously. A simple example of a context rule 23 would be “IF condition X, THEN action Y”. The rule is evaluated by checking it in a “rule engine” in the form of the monitoring device 30, which may be a program module of the controller 11, for example.

As a result, the system forms the basis for triggering defined actions at particular times after a known context has been detected. Executing actions such as notifications, recommendations and automation, interaction via an infotainment system (human machine interface, HMI). The execution of follow-up actions (in line with the control instructions 22) in accordance with a context rule 23 corresponds to the use of the generated context information. Follow-up actions can be, for example, notifications to the user, suggestions for the user, automatic start-up of another function that has so far been inactive, changing vehicle settings, or activating/adjusting actuators such as a garage door. The interaction via the HMI for notifications, for example, can then be a combination of visual, acoustic or haptic elements.

FIG. 5 shows the design of domain-specific adapters in the form of gateway devices 7, 19, in the above-described manner. The gateway devices 7, 19 acting as adapters allow heterogeneous functional components 5, 17 to communicate with one another regardless of domain. In functional terms, the adapters adjust various data structures to one another and act as protocol implementers. One option for their implementation is, for example, control units in a gateway to the respective domains. In everyday language, the aim is for the outside world, e.g. a SmartHome domain 16 of the residential building 3, to communicate with the vehicle world, the proprietary communication of each domain being harmonised by means of these adapters.

It may also be possible to manage the last known status of functional components 5, 17. In each domain 14, 16 there are functional components 5, 17, each of which can be, for example, a light switch, volume control, remaining range, distance to destination, or seat occupation. A functional component 5, 17 carries information on itself and on the status (current state) it is currently experiencing. The management of the last known status of a functional component 5, 17 is important since it is used to determine the context. The domain 14, 16 in which the functional component 5, 17 is located is irrelevant in this respect. In addition, the last known status is used whenever a problem arises, e.g., malfunction of the communication network. For many applications, correctness in terms of potential consistency is sufficient (see the CAP theorem for distributed computer systems).

The communications mechanism between the loosely coupled functional components 5, 17 is implemented by middleware, i.e., a message queue, that can be provided for example in the respective gateway devices 7, 17. The middleware links together all the involved system components. Preferably, a technology based on the publish-subscribe paradigm is used. Advantages over the classic request-response method are as follows:

asynchronous/synchronous communication,

server/service does not need to be immediately available,

message queues,

mostly shorter execution times,

loose coupling of components such as server and clients means more flexibility and exchangeability,

increased system availability,

concurrent message processing is possible.

By means of the operator device 25, e.g., in the terminal 2, the user 26 can implement their own context rules 23, i.e., preferred usages, in a very simple and intuitive manner. As shown in FIG. 7, a context rule 23 consists of a condition part 33 having e.g., a trigger 34 (TRIGGER), optionally an additional condition 35 (CONDITION), and an action part 36 (ACTION) that specifies the control instructions 22 for an action (follow-up action). Each trigger 34 specifies context messages 21 as possible selections in associated fields for creating a context rule 23. These possible selections correspond to the context messages 21 in the condition part 33 and to the control instructions 22 in the action part 36.

In design terms, this approach forms an IF-THEN rule in the form: “IF condition X, THEN action Y”. FIG. 8 shows an example of a context rule 23 applied by the operator device 25 itself: if the fact that the motor vehicle 1 is closer to the residential building 3 than a predefined maximum distance 37 therefrom is reported as a context message 21 (signaled as a context message 21 for the trigger 34 by a positioning device of the motor vehicle 1), the relevant control instruction 22 should involve a building light being switched on (LIGHT SWITCHED ON), the garage door being opened (GARAGE OPENED) and a welcome message MSG being displayed in the motor vehicle 1. This welcome message MSG can read, for example: “Welcome home! The lights have been switched on inside and the garage has been opened.”

A series of context rules 23 associated with a user 26 can be combined to form a control profile.

Alternatively, context rules 23 can also be learned automatically by means of machine learning methods and algorithms. These could then be provided in a list, the user 26 being able to select/deselect individual learned context rules 23.

The context rules 23 can be divided between different users 26. By means of context rules 23 created by users 26 or context rules 23 learned automatically, synchronization with the server 12 can be carried out anonymously. As a result, a company is able to carry out an evaluation in terms of new and frequently used context rules 23.

Selected context rules 23 can again be divided among all users 26 and offered to them. For this purpose, the rules are sent to the vehicle 1 and, after the user 26 agrees, are assigned to the control profile of the user. As a result, the functionality can be updated and improved even after the vehicle 1 has been delivered to the user 26. Since vehicles may be used by multiple people, personalization or a multi-user concept is provided so that every driver can use their own control profile.

The context rules 23 are operated and evaluated in the vehicle (independently of mobile communications networks) as well as in a synchronized manner on the server 12 (to allow a manufacturer to analyze the rules for new control suggestions).

As an example of an offboard domain 16, integration with the SmartHome of a residential building 3 will be described below. The gateway 19 is a component positioned on the domain 16 side. The monitoring device 30 is operated in the controller 11. In between there is a communications interface, such as middleware, e.g., using a publish-subscribe approach on the basis of the MQTT (message queue telemetry transport) protocol, for example. In the procedure, the special gateway 19 operates the protocol implementation and thus abstracts the proprietary control units for a specific technology, thereby allowing for standardized communication into the vehicle world. As described above, the status messages, information messages (context messages 21) and command messages (control instructions 22) in relation to the various functional components 17 of the residential building 3 travel via the communications interface.

A wide range of applications that can be implemented by means of the described method are conceivable. As a result, functional components 5, 17 possibly located in the vehicle 1 or in another domain 16 can be controlled based on personal and/or environmental and/or weather-related aspects. One possible application is e.g., adapting the sound focus to the seat occupation, as shown in FIG. 9, which shows how seat occupations 38 are signaled, and then a noise focus 39 is positioned by means of a plurality of speakers. This is an example of coordinating operation of onboard functional components 5 with one another.

Another application is automatic fuel tank recommendations when the remaining range is too low compared with the distance to the intended destination. Automatically switching on the heated seats when the external or internal temperature drops below a particular value is also possible. These are further examples of coordination between onboard functional components.

It is also possible to show the user a message when the vehicle approaches predefined, topical points of interest (POI), e.g., restaurants or sights, in particular according to the interests or preferences of the user. The message can be given for example in the form of a notice in the infotainment system together with extra information on the POI (visually and/or acoustically and/or haptically).

In addition, a delay message can be generated by SMS (short message service), for example, when a delay is detected in relation to an appointment (e.g. by comparing the vehicle position and the destination).

These are examples of coordination of onboard and offboard functional components with one another.

The desired actions can thus be executed at the correct time. This makes things easier for users since the vehicle takes over users' tasks by automatically triggering actions in line with the current context.

Users are always informed and can conveniently take action from within the vehicle. Users can be notified of specific recommendations on the basis of the user preferences.

Users can determine the desired behavior themselves via their own context rules. The system behavior is transparent for users. Users can select rules from a predefined list or by intuitively creating their own rules (via the operator device 25). Rules can be learned automatically before and after the vehicle is delivered to the user by means of learning methods and data analysis (e.g. machine learning). In principle, the method can be operated only in the vehicle 1, only on the server 12, or in both at the same time when the control profiles and statuses are synchronized accordingly. One advantage of operation within the vehicle 1 is that it is independent of the mobile communications connection 9 for vehicle-based applications. One advantage of operation on the server 12 is that functional parts can be updated more simply.

Overall, the example shows how the invention makes it possible to provide a method for operating a vehicle in which status changes occur.

1.-11. (canceled)

12. A method for coordinating operation of at least one functional component in a motor vehicle with operation of another functional component of the motor vehicle or with operation of at least one functional component not on board the motor vehicle, the method comprising:
receiving, at a controller, a first context message from a gateway device of an onboard domain;
receiving, at the controller, a second context message from a gateway of an offboard domain,
wherein the onboard domain comprises the at least one functional component in the motor vehicle and the offboard domain comprises the at least one functional component not on board the motor vehicle, and
wherein each context message is generated for its respective domain and describes a current situation occurring in its respective domain, and each context message is generated from sensor data or status data of the at least one functional component of its respective domain in accordance with a respective predefined aggregation instruction or is generated from at least one other context message;
providing, in a memory device of the controller, at least one context rule generated in an automated manner or defined by a user using an operator device;
determining, using a monitoring device of the controller, at least one predefined control instruction for the at least one functional component of its domain based on the at least one context rule and its respective context message received by the controller or based on at least on a received context message using a separate aggregation instruction; and
controlling, using the monitoring device of the controller, each functional component using the determined at least one predefined control instruction,
wherein at least one of the context messages is generated in accordance with the predefined aggregation instruction by combining the sensor data of a plurality of functional components of their respective domain or based on at least one other context message in order for a situation description to be abstracted or broken down.

13. The method according to claim 12, wherein the at least one functional component of the onboard domain comprises at least one of: an infotainment system, a seat adjustment control unit, a heating element, an air-conditioning or ventilation device, a lighting device, a positioning device, or a navigation device.

14. The method according to claim 13, wherein the seat adjustment control unit comprises a motor for adjusting a seat position.

15. The method according to claim 12, wherein the at least one offboard domain comprises at least one of:
an appliance network of a building comprising at least one domestic appliance as the at least one functional component,
a portable mobile terminal comprising at least one application program as the at least one functional component, or
an internet area comprising at least one internet service as the at least one functional component.

16. The method according to claim 12, wherein each gateway device of its respective domain is configured to convert the respective context message into a predefined message format before sending it.

17. The method according to claim 12, wherein the predefined aggregation instruction is executed by the respective gateway device, by the at least one functional component of the respective domain, or the controller.

18. The method according to claim 12, wherein the controller is provided by a server apparatus not on board the motor vehicle and receives the first context message from the gateway device of the onboard domain.

19. The method according to claim 12, wherein the controller is provided in the motor vehicle.

20. The method according to claim 12, wherein:
the at least one context rule comprises a condition part and an action part,
the condition part describes at least one of the first context message or the second context message,
the action part describes the at least one predefined control instruction, and
the condition part and the action part are linked to form an IF-THEN rule.

21. The method according to claim 12, further comprising:
configuring context rules during operation of the motor vehicle;
adding the context rules during the operation of the motor vehicle; or
deleting the context rules during the operation of the motor vehicle.

22. A controller configured to control at least one functional component based on at least one context rule, the controller comprising:
a receiver device configured to:
receive, from a gateway device of at least one offboard domain, context messages describing a current situation occurring in the at least one offboard domain, and
receive, from a gateway device of at least one onboard domain of a motor vehicle, context messages;
a memory device configured to provide at least one context rule defined by a user using an operator device or at least one context rule generated in an automated manner; and
a monitoring device configured to:
determine at least one predefined control instruction for a functional component of one of the domains based on the at least one context rule and the respective context messages or based on at least one received context message using a separate aggregation instruction, and
control, using the determined at least one context rule, the functional component stated in the determined at least one context rule,
wherein at least one of the context messages is generated based on at least one other context message in order for a situation description to be abstracted or broken down.

23. The controller according to claim 22, wherein the controller is configured to receive the at least one of context messages that was generated by combining sensor data of a plurality of functional components in one of the domains.

24. A motor vehicle comprising:
a controller; and
at least one functional component, wherein the at least one functional component is coupled to the controller,
wherein the controller comprises:
a receiver device configured to:
receive, from a gateway device of at least one offboard domain, context messages describing a current situation occurring in the at least one offboard domain, and
receive, from a gateway device of at least one onboard domain of the motor vehicle, context messages, wherein the onboard domain comprises the at least one functional component;
a memory device configured to provide at least one context rule defined by a user using an operator device or at least one context rule generated in an automated manner; and
a monitoring device configured to:
determine at least one predefined control instruction for a functional component of one of the domains based on the at least one context rule and the respective context messages or based on at least one received context message using a separate aggregation instruction, and
control, using the determined at least one context rule, the functional component stated in the determined at least one context rule,
wherein at least one of the context messages is generated based on at least one other context message in order for a situation description to be abstracted or broken down.
